(19) United States
(12) Patent Application Publication
(10) Pub. No.: US 2015/0303461 A1
(43) Pub. Date: Oct. 22, 2015

(54) COMPOSITE MATERIALS FOR RECHARGEABLE ZINC ELECTRODES

(71) Applicants: LIN-FENG LI, CROTON-ON-HUDSON, NY (US); QUAN FAN, MOHEGAN LAKE, NY (US); MIN CHEN, MILLWOOD, NY (US); WENCHAO ZHOU, CROTON-ON-HUDSON, NY (US)

(72) Inventors: LIN-FENG LI, CROTON-ON-HUDSON, NY (US); QUAN FAN, MOHEGAN LAKE, NY (US); MIN CHEN, MILLWOOD, NY (US); WENCHAO ZHOU, CROTON-ON-HUDSON, NY (US)

(21) Appl. No.: 14/520,513

(22) Filed: Oct. 22, 2014

Related U.S. Application Data
(60) Provisional application No. 61/894,455, filed on Oct. 23, 2013.

(51) Int. Cl. H01M 4/36; C04B 35/628; H01M 10/30; H01M 4/48; H01M 4/62

(52) U.S. Cl. CPC H01M 4/366; H01M 4/483; H01M 4/625; H01M 10/30; C04B 35/62839; H01M 2004/027

(57) ABSTRACT

A negative electrode for a rechargeable battery comprises a zinc oxide member doped with one or more metals and thereafter coated with a conductive layer of carbon or carbon doped with an element selected from the group consisting of fluorine, nitrogen, boron, and a mixture of two or more thereof. The electrode material is prepared by admixing ZnO or doped ZnO with carbon or a carbon-based material and then heating the admixture to form ZnO with a conductive layer. The ZnO can be doped with a first metal and then a second metal.

### CROSS-REFERENCE TO RELATED APPLICATION

This application is based upon and claims the benefit of the filing date of U.S. Provisional Patent Application Ser. No. 61/894,455, filed Oct. 23, 2013, which is incorporated herein in its entirety.

### STATEMENT REGARDING FEDERALLY SPONSORED RESEARCH OR DEVELOPMENT

The work described here was partially supported by the United States Government under Contract No. N62583-12-C-0705, awarded by the U.S. Department of Defense, and under Contract No. DE-AR0000382, awarded by ARPA-E of U.S. Department of Energy and by NYSERDA under Agreement No. 31176. The Federal Government may have certain rights in this invention.

### FIELD OF THE INVENTION

The present invention is directed to electrochemical energy storage devices and, in particular, to the batteries for such storage devices which contain a rechargeable zinc negative electrode. The invention also is directed to a method for preparing rechargeable zinc negative electrodes.

### BACKGROUND OF THE INVENTION

There is a genuine demand for high performance batteries with performance characteristics that include high power, high energy, greater reliability and safety, longer life, and low cost and that are environmentally friendly. Various battery chemistries have been explored as higher energy density alternatives for conventional lead acid and nickel cadmium batteries, as these incumbent battery technologies cannot keep up with the increasing energy requirements for new applications. Also, these conventional batteries pose great environmental problems.

Zinc has long been recognized as the ideal electrode material, due to its high specific capacity (813 Ah/kg), low electrochemical potential (namely, higher cell voltage), high coulombic efficiency, reversible electrochemical behavior, high rate capability, high abundance in the early crust and therefore low material cost, and environmental friendliness. Therefore, rechargeable zinc cells containing zinc electrodes, such as, for example, nickel/zinc, silver/zinc, MnO₂/zinc, and zinc air cells, are of significant interest.

As compared to nickel cadmium cells, a nickel/zinc cell has an open cell voltage of over 1.72 V versus 1.4 V for a nickel cadmium cell. Significant environmental issues have been found in recent years with the manufacturing and disposition of toxic nickel cadmium cells. Therefore, there is a strong need of developing high power, long cycle life, and environmental friendly rechargeable batteries with zinc as the anode material. Many batteries containing zinc electrode are known and have been practiced in the art, including non-rechargeable zinc alkaline batteries.

Despite the above advantages, conventional rechargeable zinc cells suffer short cycle life. The problem of short cycle life is now believed to have three major causes: shape change of the electrode, dendrite shorting, and electrode shedding during the cycle. In a conventional zinc electrode, zinc is dissolved into an alkaline electrolyte during discharge and re-deposited onto the electrode during charge. Zinc tends to redistribute over a number of charge/discharge cycles, which causes the electrode to change shape and reduces the battery capacity and cycle life.

Numerous approaches to improve zinc cells have been tried, including electrode additives, electrolyte additives, and membrane/separators. Previously, calcium hydroxide and others have been added in the zinc electrode formulation.

Although zinc-based batteries such as nickel-zinc battery, silver-zinc battery, and manganese oxide-zinc battery, zinc-air battery and zinc-active carbon supercapacitors demonstrate high power and high energy densities, and are low cost and free from the risk of environmental pollution upon disposal, these batteries have serious drawbacks, including zinc dendrite growth during charging which can cause short-circuits inside the cells. Many efforts had been made to solve this problem by various means, including electrolyte additives, special membranes as separator, electrolyte flow (Y. Ito, X. Wei, D. Desai, D. Steingart, S. Banerjee, Journal of Power Sources, 2012, 211, 119), and zinc electrode additives.

A comprehensive review of literature up to 1991 can be found in F. R. McLarnon, E. J. Cairns, Journal of Electrochemical Society, 1991, 138, p 645. In this review, many materials have been listed as the zinc electrode additives, including metal hydroxides, metal halides, sulfates, and titanates. In particular, alkaline earth metal hydroxides have been employed to reduce the zincate solubility by forming low solubility metal zincate, e.g., CaZn₂(OH)₆.2H₂O.

Calcium hydroxide or magnesium hydroxide powder is often mixed directly into the zinc electrode along with zinc oxide and other additives. Calcium hydroxide is known to be able to reduce the solubility of zinc discharging product, i.e., zincate (ZnO₄⁻) in alkaline electrolyte, and therefore, could potentially reduce the dendrite growth and shape change of the electrode during cycling. However, the materials thus made showed very low electric conductivity and low material utilization.

U.S. Pat. No. 3,516,862 (to W. J. van der Grinten, 1970) describes using calcium hydroxide in a zinc electrode to extend the cycle life of the nickel zinc battery.

U.S. Pat. No. 3,816,178 (to Y. Maki, M. Fujita, H. Takahashi, T. Ino, 1974) teaches a zinc electrode containing calcium hydroxide and lead oxide.

In U.S. Pat. No. 3,873,367 (to L. Kandler, 1975), electrode constructions are disclosed wherein constituents such as Ca(OH)₂ and Mg(OH)₂ are incorporated to reduce the zinc solubility in electrolyte. However, this electrode cannot endure high drain discharge service because of the formation of passive film on the zinc surface which is called passivation phenonmena.

U.S. Pat. No. 4,037,033 (to T. Takamura, et al., 1977) discloses a zinc electrode made of zinc, zinc oxide, CaO, or Ca(OH)₂, fluoride resin binder and at least one of material selected from the group consisting of bismuth oxide, bismuth hydroxide, cadmium oxide, and cadmium hydroxide. The mixture is kneaded to make a flexible sheet as the zinc electrode. The material is mechanically mixed, and the cell cycle performance is only marginally improved.

U.S. Pat. No. 4,358,517 (to R. A. Jones, 1982) teaches an zinc electrode made of zinc active material, calcium rich material, cellulose fiber, and lead compounds for high turn around efficiency and reducing gassing loss of water. The formation by mechanically mixing the materials is not uniform.

U.S. Pat. No. 5,863,676 (to A. Charkey, D. K. Coates, 1999) teaches using calcium zincate, formed by the reaction of zincate ions with calcium hydroxide, directly as the active material in a secondary battery. It did not solve the problem associated with the material, that is, low power capability, low conductivity and low charge/discharge efficiency.

J. Yu, H. Yang, X. Ai and X. Zhu, Journal of Power Sources, 2001, 103, 93, reported the chemical methods to make calcium zincate. The material was used to make the zinc electrode. X. M. Zhu, H. X. Yang, X. P. Ai, J. X. Yu, and Y. L. Cao, Journal of Applied Electrochemistry, 2003, 33, 607 and C. C. Yang, W. C. Chien, P. W. Chen, C. Y. Wu, Journal of Applied Electrochemistry, 2009, 39, 39 reported ball milling method to make the calcium zincate, which is used to make the zinc electrode.

The battery still does not resolve the issues of low power capability and low charge/discharge efficiency (from 40 to 70%). It cannot meet commercial battery requirements.

Z. Zhu in U.S. Published Patent Application No. 20060067876 A1 (2006) describes a method of making calcium zincate particles for a zinc electrode. The material has very low electric conductivity and thus low material utilization when used in the battery.

In a primary alkaline battery, small amounts (100 ppm to 1000 ppm) of bismuth and indium metal may be added to the zinc particles, which can increase the hydrogen evolution overpotential and improve the primary alkaline battery shelf life. However, the battery cannot be recharged as the secondary battery. See, for example, For example, U.S. Pat. No. 5,721,072 to J. Asaoka et al.

For the secondary zinc batteries, bismuth and indium oxide are known in the art to be added in the zinc electrode formula by mechanical mixing. The distribution of the additives is far from uniform.

In addition, zinc in contact with KOH electrolyte is thermodynamically unstable, which tends to evolve hydrogen gas causing short storage life. To reduce the zinc corrosion, several materials (for example, HgO, Tl₂O₃, PbO, CdO, In(OH)₃, Ca₂O₃, SnO₂, Bi₂O₃, and combinations thereof) have been added to the zinc electrode physically. A number of the materials, including HgO, Tl₂O₃, PbO, and CdO, are toxic and cause environmental issues. They are not suitable for non-toxic battery construction. Therefore, there is a strong need for non-toxic zinc electrode formulation.

### OBJECTS OF THE INVENTION

It is an object of the present invention to provide active materials for zinc electrodes for rechargeable batteries with greatly improved performance.

It is also an object of the present invention to provide a method of making zinc electrodes for rechargeable batteries comprising active materials and having greatly improved performance.

It is a further object of the present invention to provide non-toxic active materials for zinc negative electrodes for rechargeable batteries with greatly improved performance and a method of making the same.

It is a yet further object of the present invention to provide a zinc electrode for rechargeable batteries containing conductive carbon coated zinc oxide particles doped with oxides, salts, or hydroxides of one or more metals selected from the group consisting of calcium, magnesium, barium, aluminum, lanthanum, strontium, tin, gallium, bismuth, antimony, and indium.

It is a yet further object of the present invention to provide for rechargeable nickel-zinc cells, silver-zinc cells, zinc-air cells, Zn—MnO₂ cells, and zinc-active carbon supercapacitors. Such zinc electrodes can effectively resist corrosion in an electrolyte comprising KOH, NaOH, or a mixture thereof.

It is a yet further object of the present invention to provide a zinc electrode that can be used in rechargeable zinc cells that can effectively inhibit growth of zinc dendrites during cell charge and discharge cycles.

It is a yet further object of the present invention to provide a zinc electrode than can prevent the uneven deposition of zinc during the charging process and reduce or eliminate change of the size or shape of the zinc electrodes.

It is a yet further object of the present invention to provide non-toxic materials useful for rechargeable zinc negative electrodes.

It is a yet further object of the present invention to provide a method of manufacturing zinc electrodes suitable for rechargeable batteries.

It is a yet further object of the present invention to provide a zinc electrode for a rechargeable battery where the high power capability of the zinc negative electrode can be preserved.

These and other objectives of the invention will become apparent below in the light of the present specification, claims, embodiments and drawings.

### SUMMARY OF THE INVENTION

The present invention provides an improved composite material for a zinc negative electrode for a rechargeable battery. It has been discovered, surprisingly, that by encapsulating the active materials of the electrode with a highly conductive carbon layer or element doped carbon layer, the cycle stability of the electrode can be dramatically improved as can the charge/discharge efficiency. In addition, the zinc electrode power can also be increased.

Zinc cells have excellent characteristics. Unfortunately, the short cell cycle life of the battery prevents their commercial application as a secondary battery. An advantage of zinc negative electrodes made of the materials of this invention is the resulting excellent cycle life.

As set forth herein, a negative electrode for a rechargeable battery comprises a zinc oxide member doped with one or more metals, which zinc oxide member is thereafter coated with a conductive layer of carbon. The zinc oxide member is doped with an oxide, salt, or hydroxide of a first metal and thereafter with the oxide, salt, or hydroxide of a different second metal, before coating. The first metal is selected from the group consisting of calcium, magnesium, barium, aluminum, lanthanum, and strontium, and the second metal is selected from the group consisting of tin, gallium, bismuth, antimony, and indium.

In a preferred embodiment, the zinc oxide member is doped with from 0 to 50% by weight based on the weight of the zinc oxide of an oxide, salt, or hydroxide of at least one metal selected from the group consisting of calcium, magnesium, barium, aluminum, lanthanum, and strontium. Preferably the zinc oxide member is doped with from 50 ppm to 50% by weight of zinc oxide of an oxide, salt, or hydroxide of at least one metal selected from the group consisting of tin, gallium, bismuth, antimony, and indium.

The doped zinc oxide is coated with a conductive layer of either carbon or carbon doped with an element selected from the group consisting of fluorine, nitrogen, boron, and a mixture of two or more thereof. For example, the doped zinc oxide can be first coated with one or more polymers selected from the group consisting of fluoropolymers, nitrogen-containing polymers, boron-containing polymers, and combinations thereof, followed by hydrothermal treatment and high temperature sintering in an inert gas atmosphere.

The zinc electrode member may also comprise binders, conductive additives, or binders with conductive additives. Useful conductive additives include carbon black, graphite, or a combination thereof.

The zinc electrode members described herein are useful in conventional rechargeable batteries. Such batteries comprise a positive electrode, a negative electrode, a separator, and electrolyte. Typical electrolytes include, but are not limited to, KOH. NaOH, and mixtures thereof. The rechargeable batteries within the scope of the invention include, but are not limited to, zinc-air, zinc-nickel, zinc-MnO₂, and zinc-AgO batteries and a zinc-carbon supercapacitor.

An aspect of the invention is directed to an improved method of making zinc electrode materials for a rechargeable battery. Consistent with the improvement, according to the method wherein a doped ZnO-containing mixture is first coated with one or more polymers selected from the group consisting of fluoropolymers, nitrogen-containing polymers, boron-containing polymers, and combinations thereof, there is an additional aspect wherein the coated ZnO-containing mixture is heated to form a carbon or doped carbon layer on the surface of ZnO particles. The coated mixture is heated to from 500° C. to 1000° C., preferably from 600° C. to 900° C. The carbon may be doped with an element selected from the group consisting of fluorine, nitrogen, boron, and a mixture of two or more thereof.

Zinc electrodes of the invention can effectively resist corrosion in an electrolyte made of KOH, NaOH or a mixture thereof. Also, the zinc electrodes that can be used in rechargeable zinc cells can effectively inhibit zinc dendrite growth during cell charge and discharge cycles. Further, the zinc electrodes of the invention can prevent the uneven deposition of zinc during the charging process and reduce or eliminate changes in shape or size of the electrodes.

According to another aspect of the invention, non-toxic materials are used for rechargeable zinc negative electrodes.

According to another aspect of the invention, a high power capability of the zinc negative electrode can be preserved.

According to another aspect of the invention, a thin conductive layer is coated on the surface of the materials, which can dramatically enhance the material conductivity and utilization, as well as the cycle and power capability.

According to another aspect of the invention, a uniform conductive carbon coating on the zinc electrodes can be prepared through hydrothermal reaction followed by sintering in an inert atmosphere at temperatures of from 500° C. to 1000° C., preferably from 600° C. to 900° C., for a period of time effective to sinter, namely, from 0.1 to 24 hours, preferably from 2 to 10 hours.

According to the invention, a number of metal oxide dopants will be incorporated into zinc oxide uniformly through, for example, co-precipitation, chemical reaction, or wet ball milling methods. The yielding particle size can range from about 1 nm to about 100 μm, preferably from 10 nm to 10 μm. The doped zinc oxide particles will be further coated with a thin layer of carbon or doped carbon (F/N/B or mixed element doped carbon) materials. The conductive carbon layer help ensure high power capability, long cycle life, high charge/discharge efficiency, uniform current distribution, and dendrite formation.

In another aspect of the invention, a negative electrode for a rechargeable battery comprises a zinc oxide member doped with one or more oxides, salts, or hydroxides of metals and thereafter coated with a conductive layer of carbon.

In another aspect of the invention, the zinc oxide member is doped with an oxide, salt, or hydroxide of a first metal and thereafter with a different oxide, salt, or hydroxide of a second metal before coating with said conductive layer.

In another aspect of the invention, the first metal is selected from the group consisting of calcium, magnesium, barium, aluminum, lanthanum, and strontium.

In another aspect of the invention, the second metal is selected from the group consisting of tin, gallium, bismuth, antimony, and indium.

In another aspect of the invention, the zinc oxide is doped with from 0 to 50% by weight based on the weight of the zinc oxide of at least one oxide, salt, or hydroxide of a metal selected from the group consisting of calcium, magnesium, barium, aluminum, lanthanum, and strontium and with from 50 ppm to 50% by weight of zinc oxide of at least one oxide, salt, or hydroxide of a metal selected from the group consisting of tin, gallium, bismuth, antimony, and indium.

In another aspect of the invention, the particle size of the doped zinc oxide is from 1 nm to 100 μm

In another aspect of the invention, the particle size of the doped zinc oxide is from 10 nm to 10 μm

In another aspect of the invention, the doped zinc oxide is coated with a conductive layer of either carbon or carbon that has been doped with an element selected from the group consisting of fluorine, nitrogen, boron, and a mixture of two or more thereof.

In another aspect of the invention, the doped zinc oxide has a conductive carbon-containing coating prepared by heating the doped zinc oxide with one or more polymers selected from the group consisting of fluoropolymers, nitrogen-containing polymers, boron-containing polymers, and combinations thereof.

In another aspect of the invention, the conductive layer comprises from 0.01 to 20% by weight, based upon the weight of the coated zinc oxide or doped zinc oxide.

In another aspect of the invention, the conductive layer comprises from 0.5 to 5% by weight, based upon the weight of the coated zinc oxide or doped zinc oxide.

In another aspect of the invention, the doped zinc oxide also comprises one of binders, conductive additives, and binders with conductive additives.

In another aspect of the invention, the conductive additives include at least one of carbon black and graphite.

In another aspect of the invention, a rechargeable battery comprises a battery electrode as described and claimed herein.

In another aspect of the invention, the rechargeable battery is a zinc-air, zinc-nickel, zinc-MnO₂, or a zinc-AgO battery or a zinc-carbon supercapacitor.

In another aspect of the invention, a method of preparing a zinc electrode for a rechargeable battery comprises:

mixing ZnO or doped ZnO with carbon or a carbon precursor to form an admixture thereof, and

heating the admixture to from 500° C. to 1000° C. in an inert gas atmosphere to form ZnO particles having a conductive layer thereon.

In another aspect of a method of the invention, ZnO is doped by heating with an oxide, salt, or hydroxide of a first metal.

In another aspect of a method of the invention, the first metal is selected from the group consisting of calcium, magnesium, barium, aluminum, lanthanum, and strontium.

In another aspect of a method of the invention, ZnO is further doped by heating with an oxide, salt, or hydroxide of a second metal.

In another aspect of a method of the invention, the second metal is selected from the group consisting of tin, gallium, bismuth, antimony, and indium.

In another aspect of the invention, a method of preparing zinc electrode material for a rechargeable battery comprises:

mixing ZnO or doped ZnO with carbon or doped carbon precursors to form an admixture thereof;

hydrothermally treating said admixture at from 180° C. to 220° C. for an effective period of time;

drying and grinding the hydrothermally treated admixture to form a powder; and sintering the powder at from 500° C. to 1000° C. in an inert atmosphere to form ZnO/doped ZnO particles having a conductive layer thereon.

In another aspect of a method of the invention, the powder is sintered at from 600° C. to 900° C.

In another aspect of a method of the invention, the carbon precursor comprises sugar, polyvinyl alcohol, or another hydrocarbon-containing material or mixture thereof.

In another aspect of a method of the invention, the carbon precursor comprises one or more polymers selected from the group consisting of fluoropolymers, nitrogen-containing polymers, boron-containing polymers, and combinations thereof.

In another aspect of a method of the invention, the conductive layer comprises carbon or carbon doped with fluorine, nitrogen, boron, or a combination of two or more thereof.

In another aspect of the invention, a method of preparing zinc electrode material for a rechargeable battery comprises:

mixing ZnO or doped ZnO with carbon or doped carbon precursors to form an admixture thereof;

drying and grinding the admixture to form a powder;

sintering the powder a first time at about 300° C.; in an inert atmosphere; and

further sintering the powder at from 500° C. to 1000° C. in an inert gas atmosphere to form ZnO/doped ZnO particles having a conductive layer thereon.

In another aspect of a method of the invention, the powder is further sintered at from 600° C. to 900° C.

### BRIEF DESCRIPTION OF THE DRAWINGS

This invention may be more readily understood by reference to the following drawings wherein:

FIG. 1 is a schematic flowchart representing the synthesis of carbon-coated zinc oxide material for an electrode according to the invention;

FIGS. 2A and 2B are transmission electron microscope (TEM) images of carbon-coated zinc oxide material prepared according to the invention;

FIG. 3 is a graph representing the discharge efficiency of a conventional electrode versus an electrode prepared according to the invention;

FIG. 4 is a graph representing the capacity versus cycle for a conventional electrode versus an electrode prepared according to the invention;

FIGS. 5A and 5B are graphs representing current density v. voltage for a battery with a coated zinc electrode versus a battery with a pristine zinc electrode, respectively.

FIG. 6 is a graph representing cycle life test of current density versus voltage for a battery with a coated electrode.

### DETAILED DESCRIPTION OF THE INVENTION

The invention can perhaps be better understood by making reference to the drawings.

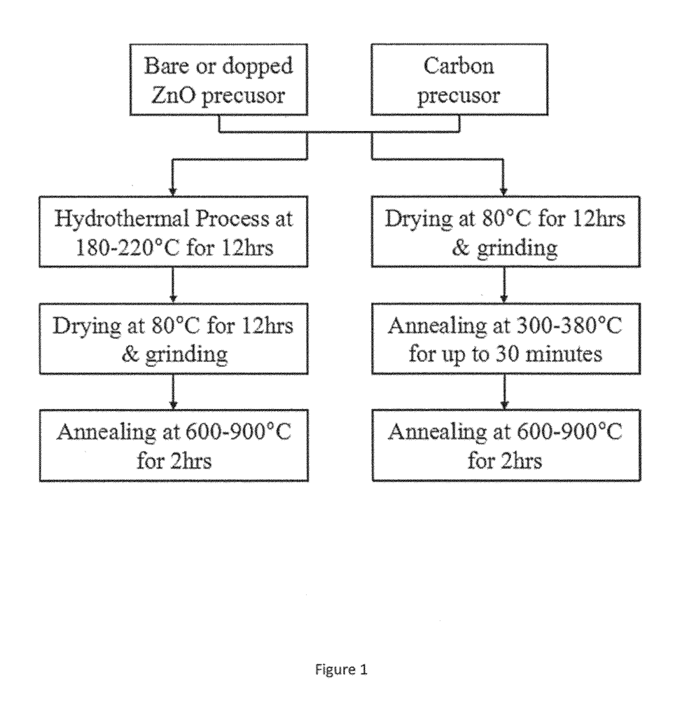

FIG. 1 is a flow chart that represents two alternate methods to prepare zinc electrodes according to the invention. ZnO or doped ZnO precursor 1 is admixed with a carbon precursor 2, in a first step. The zinc oxide may be doped with an oxide, salt, or hydroxide of a first metal and, optionally, thereafter with the oxide, salt, or hydroxide of a different second metal. The first metal is selected from the group consisting of calcium, magnesium, barium, aluminum, lanthanum, and strontium, and the second metal is selected from the group consisting of tin, gallium, bismuth, antimony, and indium. For example, ZnO can be doped with calcium in the form of a salt such as an oxide or hydroxide thereof.

Carbon precursor 2 can be hydrocarbon polymers, for example, polyvinyl alcohol, a sugar, another suitable carbon-containing material, or one or more polymers selected from the group consisting of fluoropolymers, nitrogen-containing polymers, boron-containing polymers, and combinations thereof. ZnO or doped ZnO precursor 1 and carbon precursor 2 are admixed to form a ZnO/carbon admixture.

In Method 1, the ZnO/carbon admixture is subjected in Step 3 to a hydrothermal process where the admixture is heated at from 180° C. to 220° C. for about 12 hours in an autoclave (100 ml autoclave reactor from Parr Instrument). Then in Step 4, the material from Step 3 is dried at about 80° C. for 12 hours and then ground. The ground product from Step 4 is further annealed in Step 5 at from 600° C. to 900° C. for two hours.

In Method 2 the ZnO precursors/carbon precursors admixture is first dried (in Step 6) to about 80° C. for about 12 hours and then ground. The material from Step 6 is annealed in Step 7 at from 300° C. to 380° C. for up to 30 minutes. The product from Step 7 is further annealed in Step 8 at from 600° C. to 900° C. for two hours.

### EXAMPLES

### Example 1

### ZnO/C with PVA as the Precursor

ZnO/C was synthesized by polymer pyrolysis. Typically 5 g polyvinyl alcohol (PVA) powder was dissolved in 60 g deionized water under heating. An amount of 25 g ZnO powder was slowly poured into the aqueous PVA solution to form a suspension. The suspension was stirred for two hours at 25° C., and then the temperature was kept above 90° C. until most of the water vaporized. The resulting viscous slurry was further dried for 12 hours in a Vulcan 3-550 oven, available from Ney, at 120° C. to produce a solid, which solid was calcined at from 600° C. to 900° C. in an inert atmosphere in an OTF-1200X tube furnace, available from MTI Corp., to produce active powder for a Zn electrode.

### Example 2

### ZnO/Ca(OH)₂/C

ZnO, Ca(OH)₂, and water, in a weight ratio of 80 parts:20 parts:100 parts, were mixed in a planetary ball miller for four hours to form a slurry. Ten parts by weight of PVA powder were dissolved in 100 parts by weight of deionized water under heating. The ZnO/Ca(OH)₂ slurry was mixed with the aqueous PVA solution on a hot plate and stirred for two hours at room temperature. Then, the temperature was kept above 90° C. until most of the water vaporized to form viscous slurry. The resulting slurry was further dried in an oven for 12 hours to form a solid, which was calcined at from 600° C. to 900° C. in an inert atmosphere to produce the active powder for the electrode. The weight ratio of ZnO:Ca(OH)₂PVA was controlled as x:1:y, where 1<x<20 and 0.05<y<2.

### Example 3

### Carbon Coated ZnO, Ca(OH)₂—ZnO, or Ca(OH)₂—Bi₂O₃—ZnO Synthesized from Two-Step Hydrothermal and Subsequent Annealing or from Two-Step Annealing Processes

Consistent with FIG. 1, for the synthesis of carbon coated ZnO, a carbon precursor is selected from the group consisting of glucose, sucrose, hydrolyzed poly(vinyl alcohol), poly(acrylic acid), carboxymethyl cellulose, and other carbon-based polymers.

ZnO) based powders were either purchased commercially or synthesized in the lab. Bare ZnO powders (50-250 nm, available from Aldrich) and ZnO nanopowders (10-30 nm, available from US Research Nanmaterials, Inc) were purchased commercially.

Various stoichiometry of Ca(OH)₂—ZnO and Ca(OH)₂—Bi₂O₃—ZnO nanoparticles were synthesized by wet chemical method using calcium nitrate, zinc nitrate, bismuth nitrate, and sodium hydroxide precursors. In a typical synthesis of Ca(OH)₂—ZnO, an appropriate amount of zinc nitrate (Zn(NO₃)₂.4H₂O) and calcium nitrate (Ca(NO₃)₂.4H₂O) were dissolved in aqueous-iso-propanol solution in a 500 ml beaker under magnetic stirring. Aqueous iso-propanol solution of sodium hydroxide (NaOH) was also prepared in the same way. NaOH aqueous solution was added dropwise (slowly, for 45 minutes) into the Ca(NO₃)₂—Zn(NO₃)₂ solution under magnetic stirring. The reaction was allowed to proceed for two hours. The precipitated Ca(OH)₂—Zn(OH) was separated by centrifugation, washed twice with deionized water and then with iso-propanol, and finally dried at 80° C. for overnight. During drying, Zn(OH)₂ was converted into ZnO.

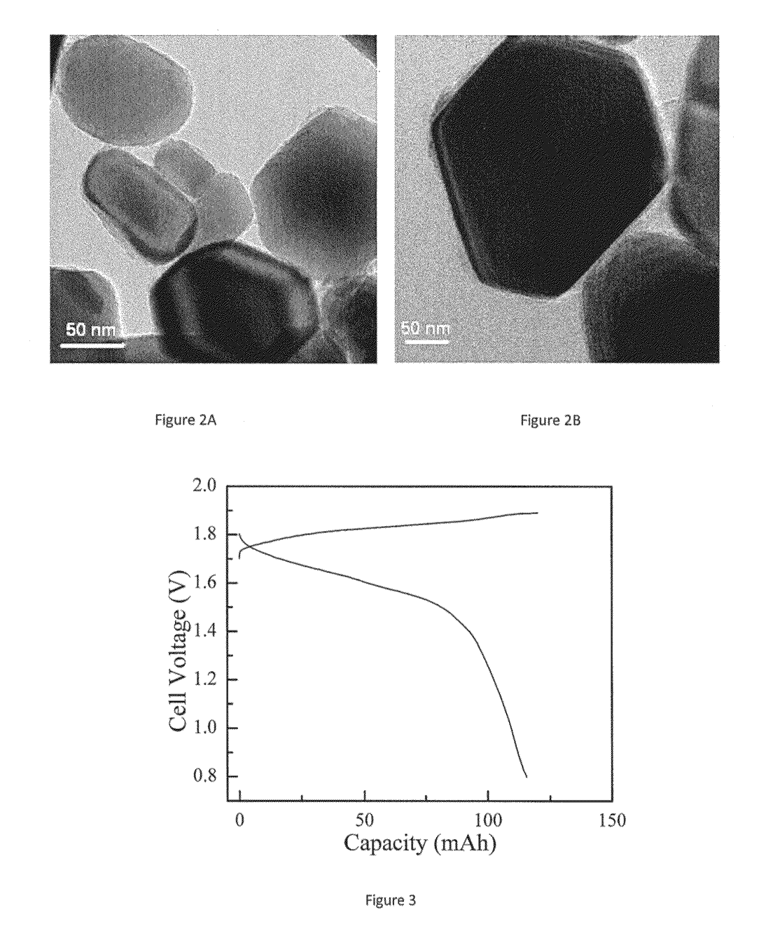

In a typical hydrothermal synthesis of 2% carbon coated ZnO nanopowder, 5 grams of glucose were dissolved in 10 ml of water under ultrasonic stirring, and 23.3 grams of ZnO powder were then suspended in the glucose solution. The ZnO-glucose mixture was agitated in a spinning mixer at a rate of 3000 rpm for two minutes. Hydrothermal processing was carried out by placing ZnO-glucose pastes in an autoclave (Parr Instrument) with a TEFLON® liner and heating to 180° C. for 12 hours. The product was then washed twice with deionized water, once with iso-propanol, was separated using centrifugation, and then was finally dried at 80° C. overnight. The dried samples were ground and then annealed at temperatures of from 600° C. to 900° C. for two hours. A TEM image of the above sample is shown in FIG. 2A, which shows thin carbon coating layer on ZnO cores.

In a typical two-step annealing synthesis of 2% carbon coated ZnO nanopowder, 5 grams of glucose were dissolved in 10 ml of water under ultrasonic stirring, and 23.3 grams of ZnO powder were then suspended in the glucose solution. The ZnO-glucose mixture was agitated in a spinning mixer at a rate of 3000 rpm for two minutes and then dried at 80° C. overnight. An annealing process was carried out by placing dried ZnO-glucose mixture in a ceramic boat and heating to a temperature of from 300° C. to 350° C. for 30 minutes, followed by cooling to room temperature. The product was washed twice with deionized water, once with iso-propanol, separated using centrifugation, and finally dried at 80° C. overnight. The dried samples were ground and then annealed at temperatures of from 600° C. to 900° C. for two hours. A TEM image in FIG. 2B shows thin, 2% carbon coated ZnO nanopowder.

### Example 4

### Ni—Zn Cells with Carbon-Coated Zinc Electrodes

A zinc electrode with a Ca:Zn molar ratio of 1:5 and a carbon coating was installed in a Ni—Zn cell. As shown in FIG. 3 this electrode demonstrated 100% charge and discharge efficiency versus 70% efficiency for a conventional uncoated electrode comprising Ca-doped zinc oxide.

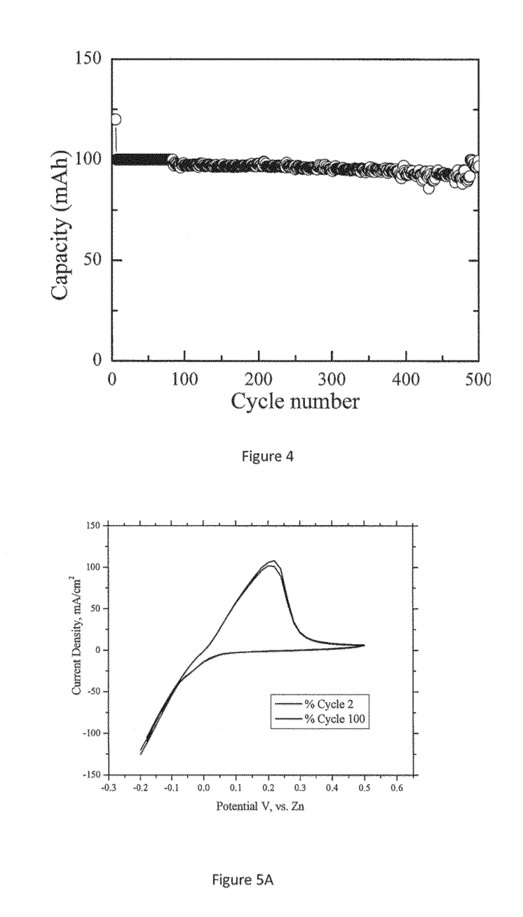

In another comparison shown in FIG. 4, an uncoated zinc electrode with a Ca:Zn molar ratio of 1:5 showed less than 100 cycles in a Ni—Zn cell while a carbon coated zinc electrode showed more than 500 cycles and is still running.

### Example 5

### ZnO Coated with CFₓ

An amount of 10 g of zinc oxide powder was mixed with 0.5 g PVdF (Kynar 2801 from Kynar.com) dissolved in acetone solvent. After drying, the polymer was well coated on the ZnO surface. The material was heated at 550° C. for one hour in inert gas (e.g., nitrogen), followed by sintering at 1000° C. for 30 minutes in inert gas. ZnO was then covered by a thin layer of CFₓ(F-doped carbon layer). Similarly, doped zinc oxide materials can be coated with a surface layer of CFₓ with the same procedure by replacing the zinc oxide powder with doped zinc oxide powder.

Comparison

The carbon coated ZnO (2% wt as made in Example 3) was used along with TEFLON binder to make the zinc electrode with copper foam as the current collector. After coating, drying, and pressing, the electrode was evaluated in a three-electrode setup in 30% KOH electrolyte (available from Aldrich) with Ni as the counter electrode and Zn wire as a reference electrode. As a comparison, a zinc electrode made with pristine ZnO (available from Aldrich) as the active material was also been made with the same procedure.

FIGS. 5A and 5B exhibit the CVs of the electrodes with a scan rate of 10 mV/s. In FIG. 5B it can be seen that a zinc electrode with pristine ZnO showed a substantial drop in activity after 100 CV cycles. On the other hand, as shown in Figure SA, a zinc electrode with carbon coated ZnO had a very minor drop in activity after 100 CV cycles, suggesting the stability of carbon coated ZnO material.

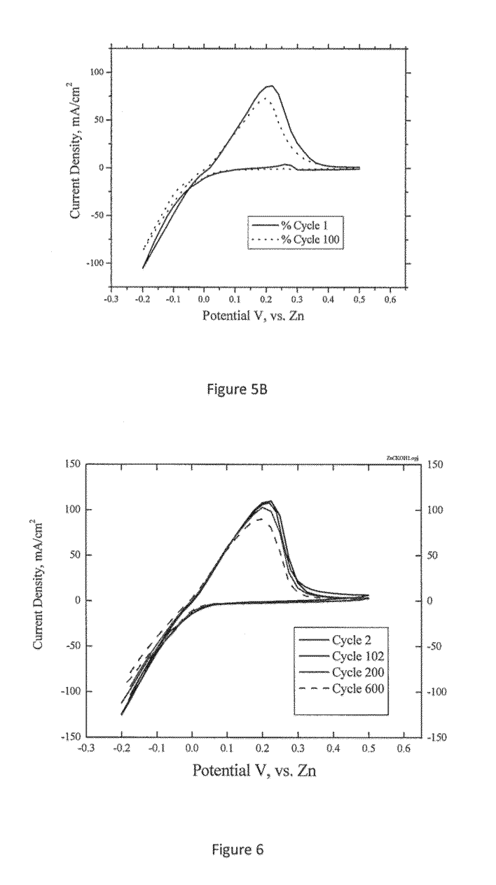

FIG. 6 represents a cycle life test of a zinc electrode made with 2% carbon coated ZnO. It can be seen that the activity drop of the zinc electrode with carbon coated zinc oxide in 600 cycles is similar to the drop of pristine zinc electrode in 100 cycles. Therefore, it is expected that carbon coated ZnO will have much better cycle stability than the pristine ZnO used in the conventional zinc electrode.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A negative electrode for a rechargeable battery,
comprising a member formed of zinc oxide particles doped with one or more metals and thereafter coated with a conductive layer of carbon or carbon doped with an element selected from the group consisting of fluorine, nitrogen, boron, and a mixture of two or more thereof.

2. The battery electrode as defined in claim 1, wherein the zinc oxide particles are doped with a first metal and simultaneously or thereafter with a different second metal before coating with said conductive layer.

3. The battery electrode as defined in claim 2, wherein said first metal is selected from the group consisting of calcium, magnesium, barium, aluminum, lanthanum, and strontium.

4. The battery electrode as defined in claim 2, wherein said second metal is selected from the group consisting of tin, gallium, bismuth, antimony, and indium.

5. The battery electrode as defined in claim 2, wherein the zinc oxide particles are doped simultaneously with a first metal and a second metal.

6. The battery electrode as defined in claim 1, wherein the zinc oxide particles are doped with from 0 to 50% by weight based on the weight of the zinc oxide of at least one oxide, salt, or hydroxide of a metal selected from the group consisting of calcium, magnesium, barium, aluminum, lanthanum, and strontium and with from 50 ppm to 50% by weight of zinc oxide of at least one oxide, salt, or hydroxide of a metal selected from the group consisting of tin, gallium, bismuth, antimony, and indium.

7. The battery electrode as defined in claim 1, wherein the particle size of the zinc oxide is from 1 nm to 100 μm.

8. The battery electrode as defined in claim 7, wherein the particle size of the zinc oxide is from 10 nm to 10 μm.

9. The battery electrode as defined in claim 1, wherein the conductive layer comprises from 0.01 to 20% by weight, based upon the weight of the doped and coated zinc oxide.

10. The battery electrode as defined in claim 9, wherein the conductive layer comprises from 0.5 to 5% by weight, based upon the weight of the doped and coated zinc oxide.

11. The battery electrode as defined in claim 1, which also comprises one of binders, conductive additives, and binders with conductive additives.

12. The battery electrode as defined in claim 11, wherein the conductive additives include at least one of carbon black and graphite.

13. A rechargeable battery which comprises a battery electrode of claim 1.

14. The rechargeable battery of claim 13, which is a zinc-air battery, zinc-nickel battery, zinc-MnO₂ battery, or a zinc-AgO battery or a zinc-carbon supercapacitor.

15. A method of preparing zinc electrode material for a rechargeable battery, which comprises:
mixing ZnO or doped ZnO with carbon or doped carbon precursors to form an admixture thereof;
hydrothermally treating said admixture at from 180° C. to 220° C. for an effective period of time;
drying and grinding the hydrothermally treated admixture to form a powder; and
sintering the powder at from 500° C. to 1000° C. in an inert atmosphere to form ZnO/doped ZnO particles having a conductive layer thereon.

16. The method as defined in claim 15, wherein the powder is sintered at from 600° C. to 900° C.

17. The method as defined in claim 15, wherein the carbon precursor comprises sugar, polyvinyl alcohol, or another hydrocarbon-containing material or mixture thereof.

18. The method as defined in claim 15, wherein the carbon precursor comprises one or more polymers selected from the group consisting of fluoropolymers, nitrogen-containing polymers, boron-containing polymers, and combinations thereof.

19. The method as defined in claim 15, wherein the conductive layer comprises carbon or carbon doped with fluorine, nitrogen, boron, or a combination of two or more thereof.

20. A method of preparing zinc electrode material for a rechargeable battery, which comprises:
mixing ZnO or doped ZnO with carbon or doped carbon precursors to form an admixture thereof;
drying and grinding the admixture to form a powder;
sintering the powder a first time at about 300° C. in an inert atmosphere; and
further sintering the powder at from 500° C. to 1000° C. in an inert gas atmosphere to form ZnO/doped ZnO particles having a conductive layer thereon.

21. The method as defined in claim 20, wherein the powder is sintered a second time at from 600° C. to 900° C.

22. The method as defined in claim 20, wherein the carbon precursor comprises sugar, polyvinyl alcohol, or another hydrocarbon-containing material or mixture thereof.

23. The method as defined in claim 20, wherein the carbon precursor comprises one or more polymers selected from the group consisting of fluoropolymers, nitrogen-containing polymers, boron-containing polymers, and combinations thereof.

24. The method as defined in claim 20, wherein the conductive layer comprises carbon or carbon doped with fluorine, nitrogen, boron, or a combination of two or more thereof.
